(19) United States
(12) Patent Application Publication
(10) Pub. No.: US 2012/0113696 A1
(43) Pub. Date: May 10, 2012

(54) Inverter System Having a Decoupling Switching Element

(76) Inventor: Klaus Voigtlaender, Wangen (DE)

(21) Appl. No.: 13/318,584

(22) PCT Filed: Apr. 22, 2010
(86) PCT No.: PCT/EP2010/055379

§ 371 Date: Jan. 20, 2012

(30) Foreign Application Priority Data
May 6, 2009 (DE) 10 2009 002 860.9

(51) Int. Cl. H02M 7/48

(52) U.S. Cl. 363/71

(57) ABSTRACT

An inverter system for converting a constant output signal of an energy-generating module, e.g., a solar cell module, into an alternating current signal, includes: an input port for receiving the constant output signal, an inverter circuit connected downstream from the input port and provided for generating the alternating current signal by switching over at least one inverter circuit element, and a decoupling switching element situated between the input port and the inverter circuit. The decoupling switching element is configured to be selectively switched over immediately before the at least one inverter circuit element is switched over in order to decouple the at least one inverter circuit element from the input port at the point in time of the switch-over.

### BACKGROUND OF THE INVENTION

1. Field of the Invention

The present invention relates to an inverter system for converting a constant output signal of an energy-generating module into an alternating current signal.

2. Description of Related Art

Inverters, in particular solar inverters, which may be designed as single-phase or three-phase units, are ordinarily used for the inversion of, for example, solar-generated energy. A basic circuit for a single-phase inversion is represented, for example, in FIG. 1, an H-bridge having four switches 101 being used for the inversion. The H-bridge is connected downstream from a solar cell 103, parallel to which a capacitor 105 is situated. The constant output signal of solar cell 103 is inverted using switches 101, each of which is switchable in pairs, and converted into an alternating current signal which is fed, for example, to an energy distribution network 107 via the pick-offs, each of which is situated between two switches 101 which are connected in series, the supply leads of the energy distribution network being represented by inductors 109.

The formation of the alternating current signal is elucidated in FIGS. 2A through 2D. Curve 201 of a setpoint current I_{SETPOINT} with reference to a curve of a voltage 203 is represented in FIG. 2A. FIG. 2B shows the states of switches 101, each of which is to be closed in pairs. FIG. 2C shows a curve of a line voltage 205 compared to a curve of a bridge voltage 207. The curves of setpoint current 209 and actual current 211 are represented in FIG. 2D.

FIG. 3 shows an embodiment of the solar inverter from FIG. 1 in which the H-bridge is connected upstream from a switch 301. The associated signal curves are represented in FIG. 4, FIG. 4A showing a curve of a current 401 and a voltage 403. The states of switch 301 and of switch 101, which are closed in pairs, are represented in FIG. 4B. As is apparent from FIG. 4B, switch 301 is switched over multiple times while a pair of switches is closed in each case, which is significant for the curve of the resulting voltage. FIG. 4C shows resulting voltage curves 405 as well as a bridge voltage 407. Setpoint current 409 and output current 411 are represented in FIG. 4D.

FIG. 5 shows the inverter from FIG. 1, to which has been added a parallel connection of two series connections, each having a switch 501 and 503 and a diode 505 and 507. When switches 501 and 503 are closed, diodes 505 and 507 are connected anti-parallel. Due to the parallel connection downstream from the H-bridge, the HERIC topology is implemented in which an output-side energy oscillation is prevented.

The associated signal curves are represented in FIG. 6, FIG. 6A showing a curve of a current 601 and a curve of a voltage 603. FIG. 6B shows the closed state of switches 101 which are operable in pairs and, in the lower diagram, the pair-wise states of switches 501 and 503. The curves of bridge output voltage 605 and setpoint voltage 607 are represented in FIG. 6C. FIG. 6D shows the curve of setpoint current 609 and of bridge output current 611.

FIG. 7 shows an inverter which is designed as a three-phase unit and has a bridge connection having six switching elements 701 through 711 for the inversion. A solar cell 713 and an energy storage 715 are situated parallel to the bridge connection. Pick-offs via which the particular phase voltage may be picked off are situated between switching elements 701 and 703; 705 and 707; 709 and 711, which are in each case connected in series. The pick-offs are, for example, connected to a three-phase energy distribution network, the supply leads of which are characterized by inductors 717, 719 and 721.

FIG. 8 shows an inverter which, in contrast to the inverter represented in FIG. 7, has switches 821, 823 and 825 assigned to the particular phases, which may be used for short-circuiting the particular phase.

FIG. 9 shows an inverter which, in contrast to the inverter shown in FIG. 8, has a charging capacitor which is composed of two distributed capacitors 901 and 903. A nodal point between these capacitors is conducted to the outside and is used as a reference potential terminal, making it possible to implement a “floating” ground.

However, the topologies described above have the disadvantage that when the particular switch is switched over, energy is fed into the capacitors and solar cells in the reverse direction, which reduces the efficiency of the inversion. The internal semiconductor resistors are another source of loss. Moreover, when the switches are switched over, additional switching losses occur, in particular at high clock frequencies, which at present may only be minimized by short-circuiting the particular bridge topology.

### BRIEF SUMMARY OF THE INVENTION

The present invention is based on the finding that it is possible to increase the efficiency of an inversion using an inverter bridge having at least one switch by separating the inverter bridge from any energy source at the point in time at which the switch is switched over. This makes it possible for the at least one switch to be switched over energy free, whereby transient switching currents may be avoided. Immediately after the at least one switch is switched over, the inverter circuit is again connected to the energy source. This also avoids the charge reversal of the energy source, for example, a solar cell, as well as, if necessary, of a charging capacitor connected in parallel to it.

The present invention relates to an inverter system for converting a constant output signal of an energy-generating module, for example, a solar cell module having at least one solar cell, into an alternating current signal, having an input port for receiving the constant output signal from the energy-generating module, an inverter circuit connected downstream from the input port and provided for generating the alternating current signal by switching over at least one inverter circuit element and having a decoupling element, which is situated between the input port and the inverter circuit, it being possible for the decoupling switching element to be switched over immediately before the at least one inverter circuit element is switched over in order to decouple the at least one inverter circuit element from the input port at the point in time at which the inverter circuit element is switched over. This makes it possible to switch the inverter circuit element in an energy-free manner.

According to one specific embodiment, it is also possible for the decoupling switching element to be switched over immediately after the at least one inverter circuit element is switched over, in order to couple the at least one inverter circuit element to the input port immediately after the switch-over. In this way, the constant output signal, which may be a voltage signal or a current signal, is applied to the at least one inverter circuit element, for example, in the closed state.

According to one specific embodiment, the decoupling switching element is openable immediately before the switch-over, in particular closure, of the at least one inverter circuit element and/or is closable immediately after the switch-over, in particular closure, of the inverter circuit element. This causes, for example, the at least one inverter circuit element to be opened or closed only if the decoupling switching element is opened, so that energy-free switching may be advantageously made possible.

According to one specific embodiment, the decoupling switching element is switchable, in particular openable, before the at least one inverter circuit element is switched over into a first switching state, and switchable, in particular closable, after the at least one inverter circuit element is switched over into a second switching state, a time duration of the decoupling switching element remaining in the first state being a function of a switching cycle duration of the at least one inverter circuit element. If the at least one inverter circuit element is switched, for example, periodically at a cycle duration, the dwell time of the decoupling switching element in the first switching state, and accordingly a window within which the at least one inverter circuit element is switched, may amount to, for example, 0.1%, 1%, 1.5% or 2% of the above-mentioned cycle duration. The point in time of the switch-over of the at least one inverter circuit element may, for example, be in the center of the above-mentioned time window, so that a simple activation of the switching elements is possible.

According to one specific embodiment, the inverter system includes a control device for controlling the decoupling switching element and the at least one inverter circuit element, the control device being designed for activating the decoupling switching element before and/or after an activation of the inverter circuit element for the switch-over of the same. Since the two above-mentioned switching elements are controlled by the same control device, the time control of the above-mentioned switching elements may be performed in a particularly simple manner.

According to a specific embodiment, the decoupling switching element and the at least one inverter circuit element are switches, in particular transistor switches, making it possible to implement the switching elements advantageously in a simple manner.

According to one specific embodiment, the inverter circuit is a bridge connection, in particular an H-bridge connection or a B6 bridge connection, having a plurality of inverter circuit elements, in particular having 4 or 6 inverter circuit elements. The decoupling switching element is preferably opened, for example, before and/or after a switch-over of each inverter circuit element, making it possible to operate multi-phase, for example, three phase, inverter circuits efficiently.

According to one specific embodiment, a diode operated in the flow direction, for example, a diode connected in series to the decoupling switching element, is connected between the input port and the inverter circuit. This advantageously prevents a reverse flow of current to the input port, which may, for example, prevent a charge reversal of a charging capacitor.

According to one specific embodiment, an energy storage is switchably situated, in particular with the aid of a switch, in parallel to the input port. This makes it possible for the energy storage also to be decoupled advantageously from the at least one inverter switch at the point in time of the switch-over, making it possible to prevent a charge reversal of the energy storage.

According to one specific embodiment, the energy storage includes, for example, two capacitors situated in series, a nodal point between the two capacitors situated in series being brought out as a reference potential terminal, in particular as a ground terminal. This makes it possible to implement a “floating” ground in an advantageous manner.

According to one aspect, the present invention relates to an energy-generating system having an energy-generating module, in particular a solar cell module, having at least one solar cell, and the inverter system according to the present invention which is connected in parallel to the energy-generating module.

According to one specific embodiment, a switching element, for example, a transistor switch is connected in series to the energy-generating module, and is provided for switching the energy-generating module on or off, whereby, due to its switch-off at the point in time of the switch-over of the at least one inverter circuit element, a charge reversal of the energy-generating module may advantageously be prevented.

According to one specific embodiment, the present invention relates to a method for converting a constant output signal of an energy-generating module, for example, a solar cell module having at least one solar cell, into an alternating current signal with the aid of an inverter circuit which includes at least one inverter circuit element, including the steps of switching over the at least one inverter circuit element in order to obtain the alternating current signal based on the constant output signal by switching over the at least one inverter circuit element, and interrupting a feed of the constant element to the inverter circuit with the aid of a decoupling switching element which is switched over, in particular opened, immediately before the at least one inverter circuit element is switched over.

Additional method steps are derived directly from the functionality of the inverter system according to the present invention.

### BRIEF DESCRIPTION OF THE DRAWINGS

FIG. 1 shows an inverter system.

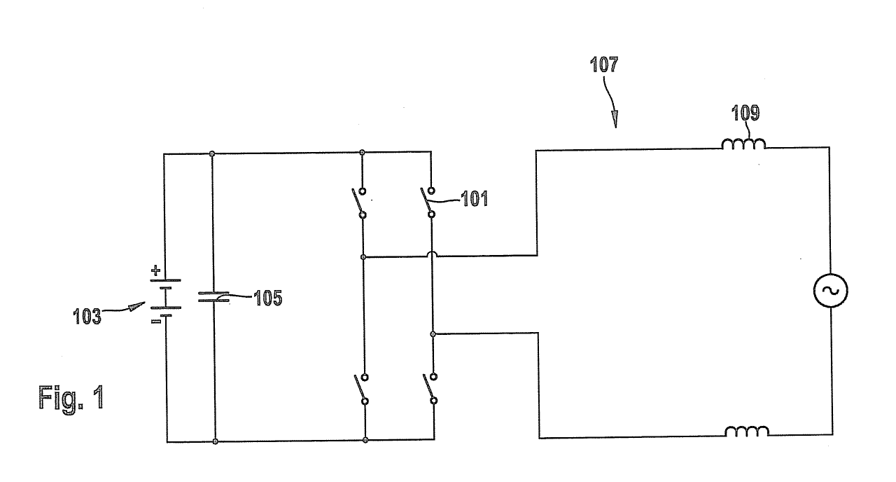

FIG. 2 shows signal curves.

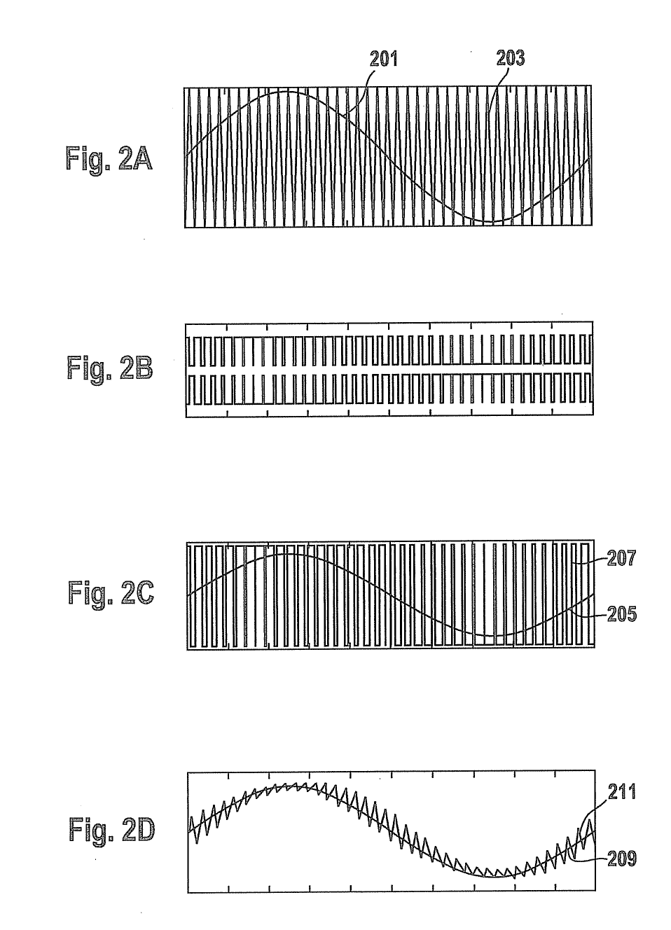

FIG. 3 shows an inverter.

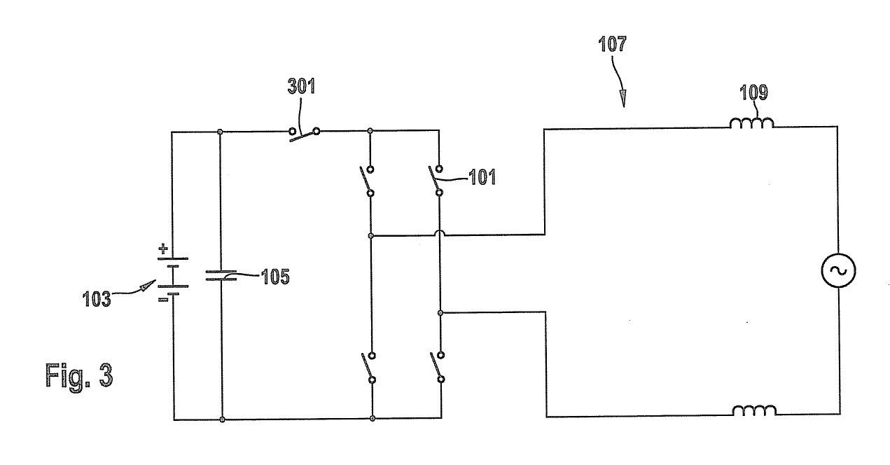

FIG. 4 shows signal curves.

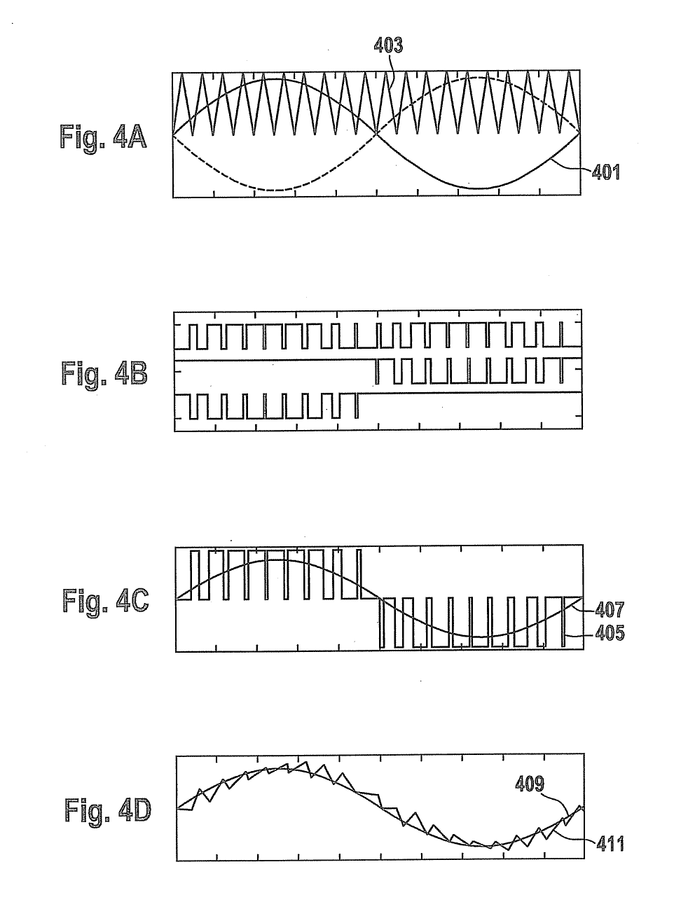

FIG. 5 shows an inverter system.

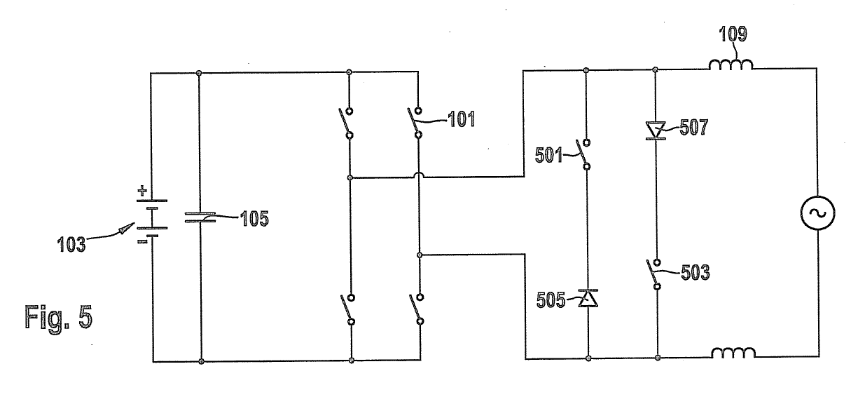

FIG. 6 shows signal curves.

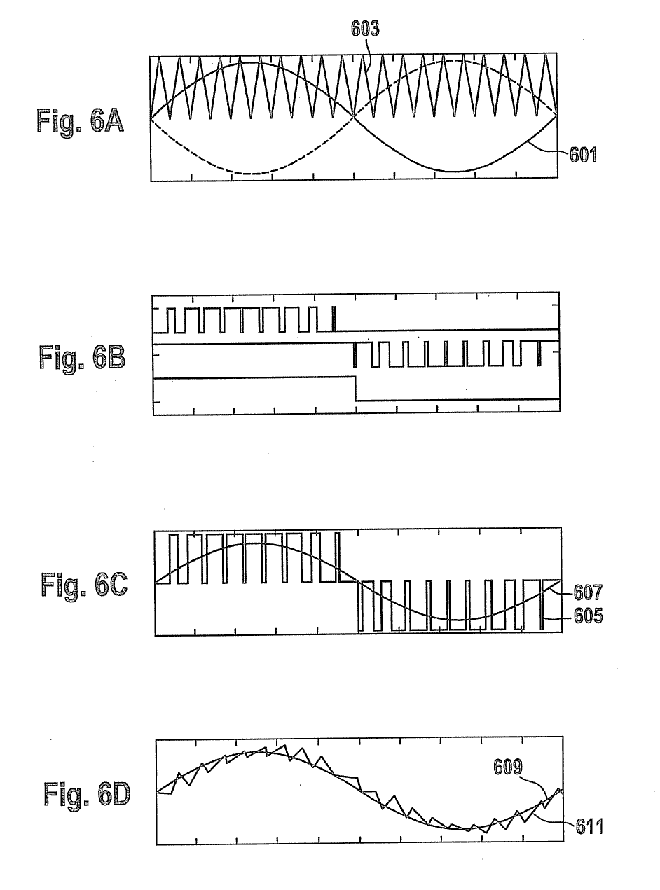

FIG. 7 shows an inverter system.

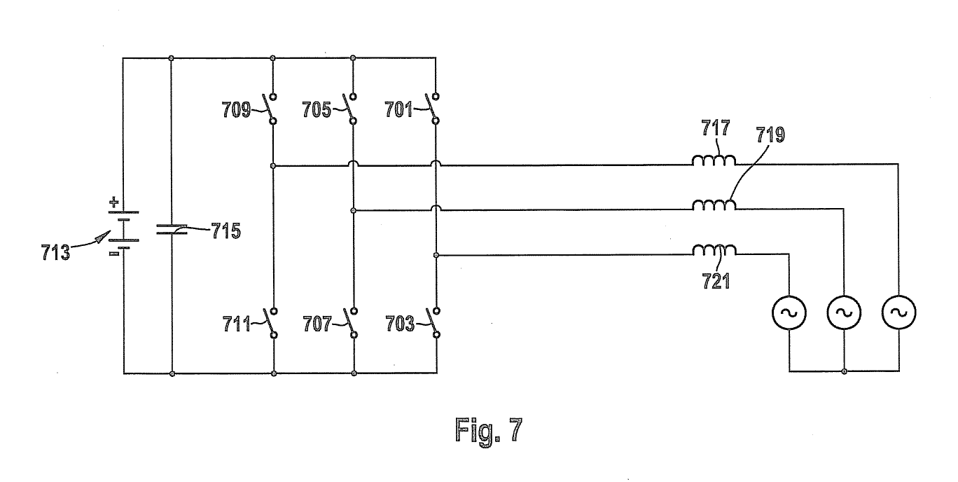

FIG. 8 shows an inverter system.

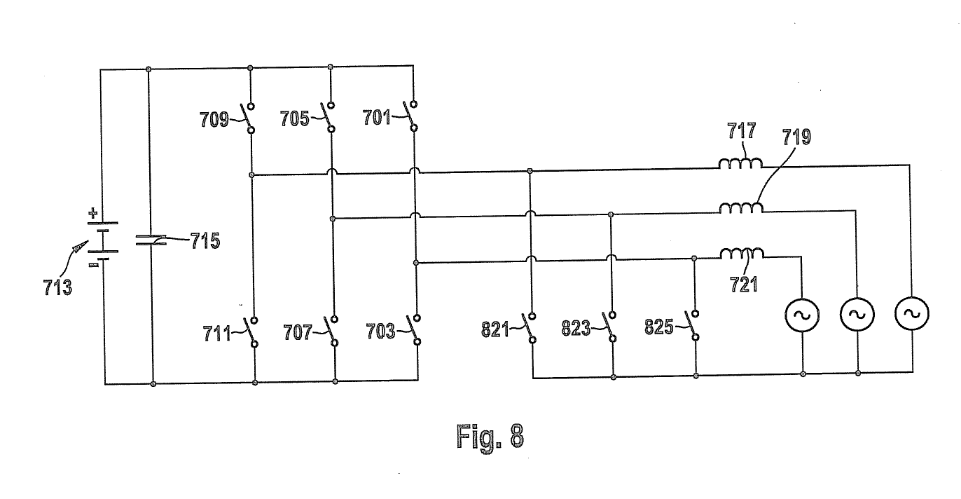

FIG. 9 shows an inverter system.

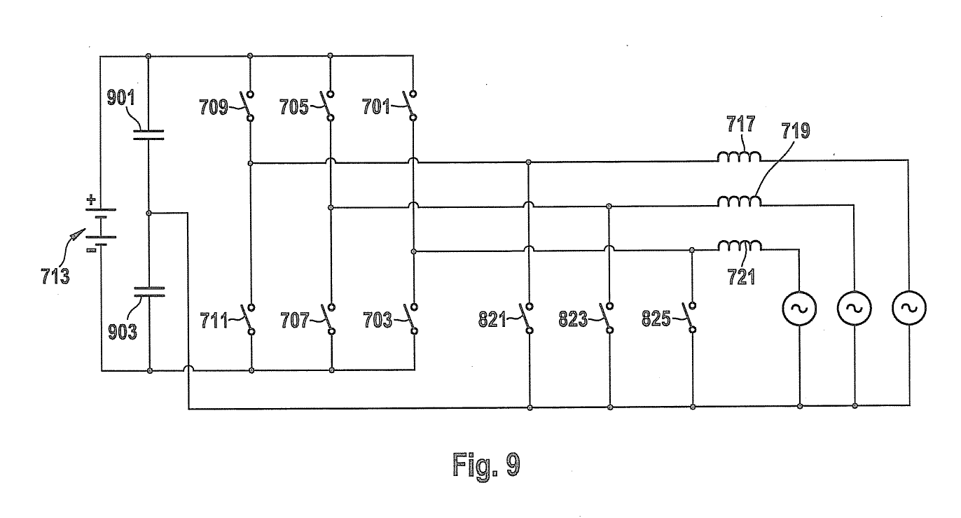

FIG. 10 shows an inverter system according to the present invention.

FIG. 11 shows an inverter system according to the present invention.

FIG. 12 shows an inverter system according to the present invention.

FIG. 13 shows a switch-over time diagram.

### DETAILED DESCRIPTION OF THE INVENTION

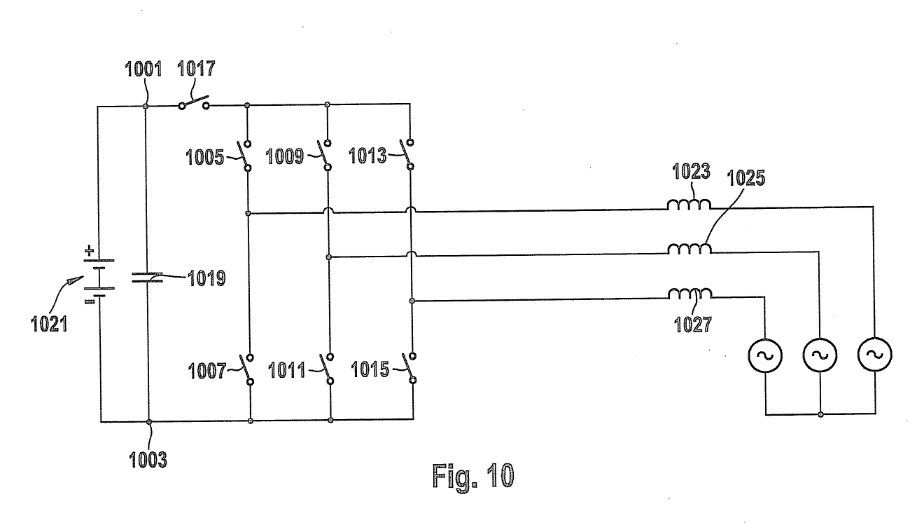

FIG. 10 shows an inverter system having an input port including terminals 1001 and 1003. An inverter circuit having switches 1005, 1007, 1009, 1011, 1013 and 1015 situated in series is connected downstream from the input port. A decoupling switching element 1017, for example, a transistor switch, is situated between the input port and the inverter circuit.

An energy storage 1019 and an energy-generating module 1021 are situated parallel to the input port and between terminals 1001 and 1003. Energy-generating module 1021 may, for example, be described by constant voltage sources connected in series and, for example, may be a solar system having at least one solar cell.

One pick-off each is situated between switches 1005 and 1007, 1009 and 1011, 1013 and 1015 connected in series in order to connect the inverter system to an energy distribution network connected downstream from it, the supply leads of which are, for example, described by inductors 1023.

For converting the constant output signal, for example, a voltage or current signal, generated by energy-generating module 1021, for example, switches 1005 and 1011 are closed during operation, resulting in the implementation of a current path having inductors 1023 and 1025. These switches are preferably closed synchronously, decoupling switching element 1017 being opened immediately before switches 1005 and 1015 are closed and then closed again immediately thereafter. If switches 1005 and 1015 are opened again, decoupling switching element 1017 is opened immediately before and then closed again immediately thereafter, making it possible to perform an additional switching cycle. Decoupling switching element 1017 is thus used solely for decoupling the switches of the inverter system at the point in time of their switch-over in order to prevent a pulse-like and reverse switching current in the direction of energy storage 1019. The brief opening of decoupling switching element 1017 a short time before the point in time of the switch-over of the particular switch, the switches being switchable in pairs, may influence a phase or a frequency of the resulting alternating current signal. This influence may, however, be adjusted, for example, with the aid of a closed loop which is set to a predetermined phase or frequency value by switching the switches of the inverter circuit, for example, faster or more slowly.

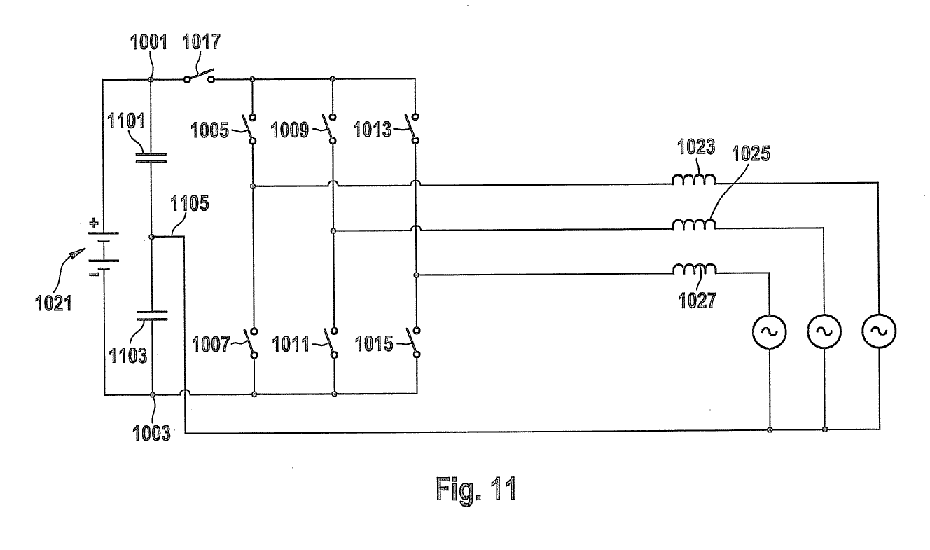

An inverter system is represented in FIG. 11, which in contrast to the inverter system represented in FIG. 10 has an energy storage including distributed capacitors 1101 and 1103 which are switched in series, situated between terminals 1001 and 1003. A pick-off 1005, for example, is situated between distributed capacitors 1101 and 1103, the pick-off being brought out as a reference potential terminal and used, for example, as a ground terminal for the energy distribution network. This advantageously implements a floating ground.

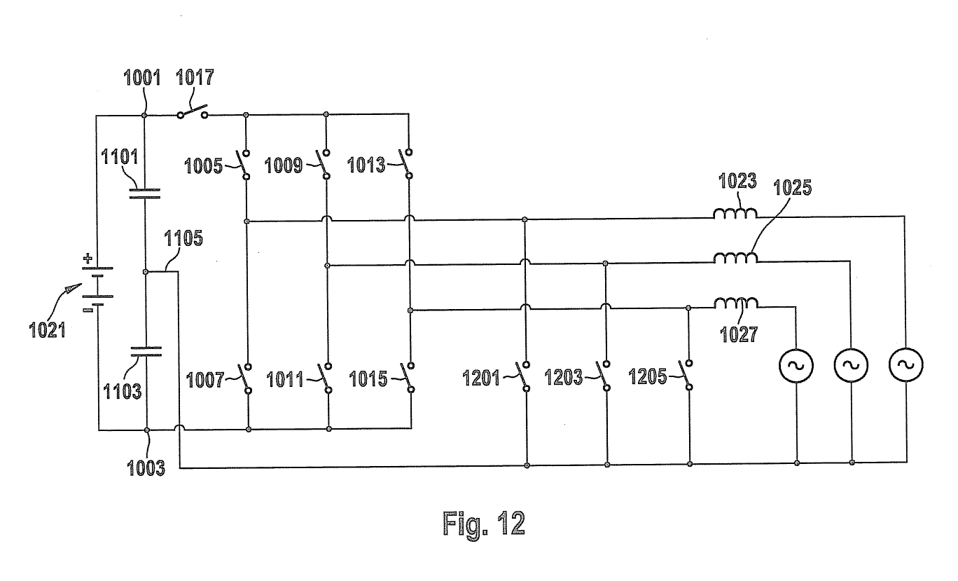

An energy-generating system is represented in FIG. 12, which in contrast to the inverter system represented in FIG. 11, includes switches 1201, 1203 and 1205, which connect the particular pick-off between switches connected in series 1005, 1007 and 1009, 1011 and 1013 and 1015 to reference potential terminal 1101. This advantageously makes it possible to short-circuit the particular phase.

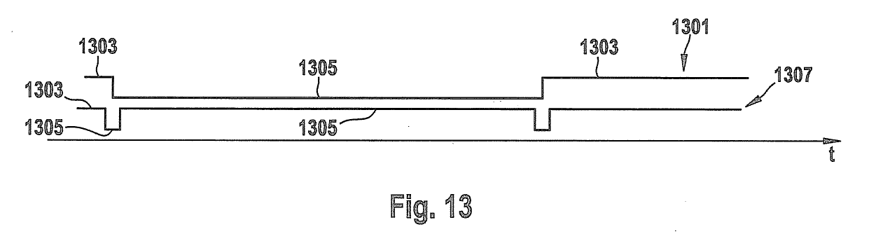

FIG. 13 shows a time diagram showing the curve over time of a switching state 1301 of one of switches 1009 through 1015 of the inverter circuit. Beginning with, for example, an opened state 1303, the switch is transitioned into a switching state 1305 and is, for example, closed. After switching state 1305, the switch of the inverter system is again transitiened into switching state 1303 and opened, for example.

Corresponding curve 1307 of decoupling switching element 1017 is represented in the lower diagram. Beginning with switching state 1303, decoupling switching element 1017 is transitioned into switching state 1305 and, for example, opened immediately before the switch is switched over. Thus a transition flank between switching states 1303 and 1305 of the switch of the inverter circuit does not coincide with a transition flank of decoupling switching element 1017. Immediately after the switching element of the inverter circuit is switched over into switching state 1305, decoupling switching element 1017 is transitioned into switching state 1305 and is closed, for example. The brief transition of decoupling switching element 1017 into switching state 1305 before and after the point in time of the switch-over of the particular switch of the inverter circuit defines a switch-over time window, the temporal length of which may last, for example, 0.1% to 1% of a switching period of the particular switch of the inverter circuit.

The concept according to the present invention may be used advantageously for inverting constant signals in solar cell systems, in wind power systems, in rotary field motors or in fan motors.

1-13. (canceled)

14. An inverter system for converting a constant output signal of an energy-generating module into an alternating current signal, comprising:
an input port configured to receive the constant output signal;
an inverter circuit connected downstream from the input port and configured to generate the alternating current signal by switching over at least one inverter circuit element; and
a decoupling switching element situated between the input port and the inverter circuit, wherein the decoupling switching element is configured to be selectively switched over to decouple the at least one inverter circuit element from the input port immediately before the at least one inverter circuit element is switched over.

15. The inverter system as recited in claim 14, wherein the decoupling switching element is further configured to be selectively switched over to couple the at least one inverter circuit element to the input port immediately after the at least one inverter circuit element is switched over.

16. The inverter system as recited in claim 15, wherein the decoupling switching element is configured to be (i) selectively opened immediately before a closure of the at least one inverter circuit element, and (ii) selectively closed immediately after the closure of the inverter circuit element.

17. The inverter system as recited in claim 15, wherein the decoupling switching element is configured to be (i) selectively switched before the at least one inverter circuit element is switched over into a first switching state, and (ii) selectively switched after the at least one inverter circuit element is switched over into a second switching state, and wherein a time duration of the decoupling switching element remaining in the first state is a function of a switching cycle duration of the at least one inverter circuit element.

18. The inverter system as recited in claim 15, further comprising:
a control device configured to control switching of the decoupling switching element and the at least one inverter circuit element.

19. New The inverter system as recited in claim 15, wherein the decoupling switching element and the at least one inverter circuit element are transistor switches.

20. The inverter system as recited in claim 15, wherein the inverter circuit element is one of an H-bridge connection or a B6 bridge connection having a plurality of inverter circuit elements.

21. The inverter system as recited in claim 15, further comprising:
a diode operated in the flow direction and connected in series to the decoupling switching element between the input port and the inverter circuit.

22. The inverter system as recited in claim 15, further comprising:
a capacitor element switchably connected in parallel to the input port.

23. The inverter system as recited in claim 15, further comprising:
an energy storage having at least two capacitors connected in series, wherein the energy storage is connected in parallel to the input port, and wherein a nodal point between the two capacitors situated in series is used as a ground terminal.

24. An energy-generating system, comprising:
an energy-generating module; and
an inverter system connected to the energy-generating module in parallel, wherein the inverter system includes:
an input port configured to receive the constant output signal;
an inverter circuit connected downstream from the input port and configured to generate the alternating current signal by switching over at least one inverter circuit element; and
a decoupling switching element situated between the input port and the inverter circuit, wherein the decoupling switching element is configured to be selectively switched over to decouple the at least one inverter circuit element from the input port immediately before the at least one inverter circuit element is switched over;
wherein the decoupling switching element is further configured to be selectively switched over to couple the at least one inverter circuit element to the input port immediately after the at least one inverter circuit element is switched over.

25. The energy-generating system as recited in claim 24, further comprising:
at least one switching element connected in series to the energy-generating module and configured to selectively switch the energy-generating module on and off.

26. A method for converting a constant output signal of an energy-generating module into an alternating current signal with the aid of an inverter circuit which includes at least one inverter circuit element, comprising:
switching over the at least one inverter circuit element in order to obtain the alternating current signal based on the constant output signal; and
interrupting a feed of the constant output signal to the inverter circuit with the aid of a decoupling switching element which is switched over immediately before the at least one inverter circuit element is switched over.
